(19) United States
(12) Patent Application Publication
(10) Pub. No.: US 2005/0179159 A1
(43) Pub. Date: Aug. 18, 2005

(54) Crystallized artificial marble using incineration ash and related fabrication method

(76) Inventors: Yeong Seok Yoo, Incheon-City (KR); Hyun Chul Shin, Incheon-City (KR); Chai Sung Gee, Koyang-City (KR); Soo Ja Um, Koyang-City (KR); Dae Yon Kim, Suwon-City (KR)

Correspondence Address: JORDAN AND HAMBURG LLP, 122 EAST 42ND STREET, SUITE 4000, NEW YORK, NY, 10168, US

(21) Appl. No.: 11/019,433

(22) Filed: Dec. 21, 2004

(30) Foreign Application Priority Data
Dec. 26, 2003 (KR) 10-2003-0097134

(51) Int. Cl. B28B 1/08; F23G 1/00

(52) U.S. Cl. 264/71; 264/73

(57) ABSTRACT

A crystallized artificial marble is fabricated using incineration ash. In a fabrication method, incineration fly ash of 50 to 80 weight percent is mixed with SiO₂ of 20 to 50 weight percent and additives of 0.1 to 3 weight percent for coloring, clarification, and reinforcing. The mixed material is melted at 1300 to 1500° C. for 0.5 to 1.5 hours and water-cooled to form granulation slag. Then the granulation slag is screened to separate fine particles according to size. After mixed with particulate, the granulation slag is deposited in a refractory die and heat-treated at 1000-1200° C. for about 1 hour or less and at 850-1050° C. for about 2 hours or less.

### BACKGROUND OF THE INVENTION

1. Field of the Invention

The present invention relates generally to an artificial marble and, more particularly, to a crystallized artificial marble fabricated using incineration ash.

2. Description of the Related Art

As the growth of industry is continuing, a variety of solid wastes are also increasing in the world at large. Municipal waste and industrial waste are mainly landfilled or incinerated, only a little being recycled or reused.

Incineration results in toxic air emissions and ash, both of which require management. Of course, although the problem of air emissions may take great parts of concerns, the treatment problem of incineration ash is also widely studied in the world.

Generally, waste combustion generates two kinds of by-products, namely, bottom ash and fly ash, which contain a great variety of elements such as CaO, Cl and SiO₂. The use of these incineration ashes has been recently attempted as main material or additives in engineering and construction industry.

In some countries, related techniques have been introduced in the art. For example, it has been reported that incineration ash was utilized as non-structural aggregate and embankment material by pre-treating bottom ash and by melting fly ash at 1300-1500° C.

Furthermore, there has appeared a technique for fabricating colored glass by mixing incineration ash with additives, melting them at 1400-1500° C., and heat-treating them at 900° C. for 2-3 hours. However, this technique may have commercial drawbacks such as poor physical strength and hardness, difficulty of manifesting surface pattern, and monotonous surface pattern.

Additionally, another technique for plasticizing incineration ash at a high temperature more than 1200° C. for 10 hours or more has been suggested. However, this technique may fail to guarantee manifestation because of physical properties.

Further another technique for melting and crystallizing incineration ash after removing chlorine element, by water washing, and drying powder has been known. However, this technique may be hard to apply to actual process since it has to treat a great quantity of incineration ash with water. And also, this technique may have additional shortcomings such as the disposal of polluted wafer, the problem of mass treatment, associated high cost, and the difficulty of complete crystallization.

### SUMMARY OF THE INVENTION

It is an object of the present invention to provide a crystallized artificial marble with vivid colors and good patterns.

It is another object of the present invention to provide a method for fabricating a crystallized artificial marble without high cost pre-treatment process such as washing and drying.

To attain the above and other objects, the present invention provides a method for fabricating a crystallized artificial marble using incineration ash, the method comprising the following steps.

The method comprises mixing incineration fly ash of 50 to 80 weight percent with SiO₂ of 20 to 50 weight percent and additives of 0.1 to 3 weight percent for coloring, clarification, and reinforcing. The method further comprises melting the mixed incineration fly ash at 1300 to 1500° C. for 0.5 to 1.5 hours. The method further comprises water-cooling the melting incineration fly ash so as to form granulation slag. Also, the method comprises screening the granulation slag so as to separate fine particles according to size. And, the method comprises depositing the granulation slag in a refractory die after mixing with particulate. And also, the method comprises heat-treating the granulation slag at 1000-1200° C. for about 1 hour or less and at 850-1050° C. for about 2 hours or less.

In the method of the present invention, the additives may include at least one coloring additive selected among TiO₂, ZrO₂, CaF₂, ZnO, PbO, Cr₂O₃, MnO₂, Co₃O₄, NiO, CuO, SeO₂, and Cd(NO₃)₂, and at least one reinforcing additive selected among Na₂O, B₂O₃, and CaF₂.

Furthermore, the present invention provides a crystallized artificial marble fabricated from the above-described method.

### BRIEF DESCRIPTION OF THE DRAWINGS

FIG. 1 is a view showing a fabrication process of a crystallized artificial marble using incineration ash in accordance with an exemplary embodiment of the present invention.

FIG. 2 is a graph showing a temperature schedule used in a fabrication process of a crystallized artificial marble using incineration ash in accordance with an exemplary embodiment of the present invention.

FIG. 3 is a photograph showing crystallized artificial marbles using incineration ash in accordance with an exemplary embodiment of the present invention.

FIG. 4 is a photograph showing precipitate phase produced during heat treatment in a fabrication process of a crystallized artificial marble using incineration ash in accordance with an exemplary embodiment of the present invention.

### DETAILED DESCRIPTION OF EXEMPLARY EMBODIMENTS OF THE INVENTION

Exemplary, non-limiting embodiment of the present invention will now be described more fully hereinafter with reference to the accompanying drawings. This invention may, however, be embodied in many different forms and should not be construed as limited to the exemplary embodiments set forth herein. Rather, the disclosed embodiments are provided so that this disclosure will be thorough and complete, and will fully convey the scope of the invention to those skilled in the art. The principles and feature of this invention may be employed in varied and numerous embodiments without departing from the scope of the invention.

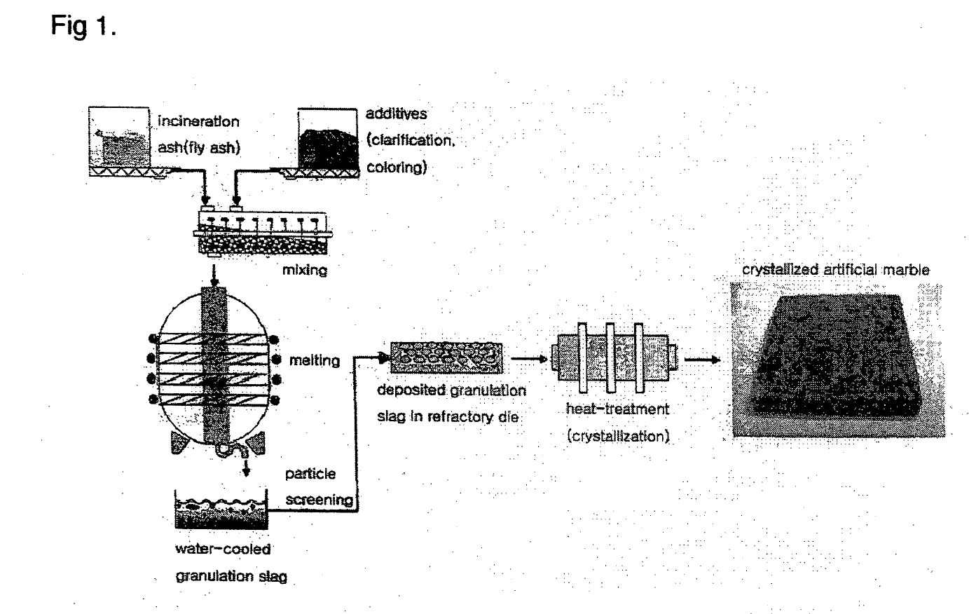

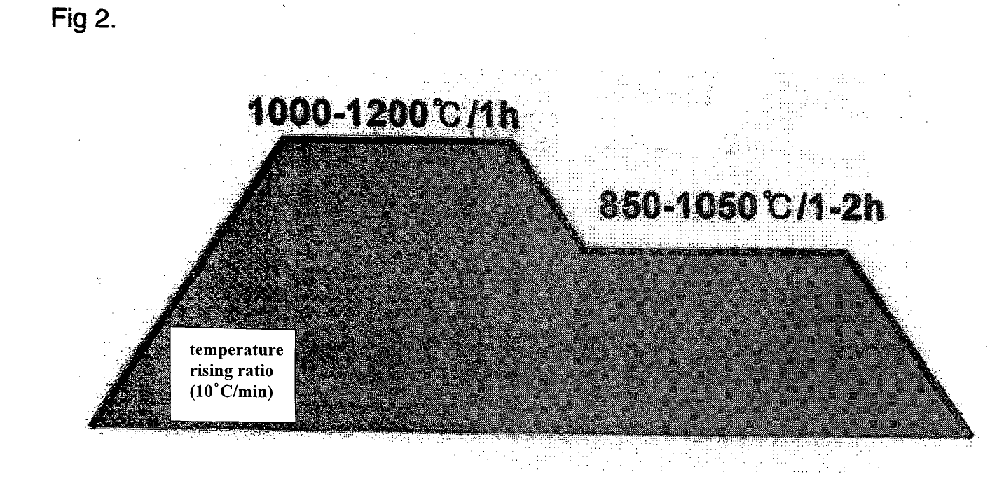

FIG. 1 is a view showing a fabrication process of a crystallized artificial marble using incineration ash in accordance with an exemplary embodiment of the present invention. FIG. 2 is a graph showing a temperature schedule used in a fabrication process of a crystallized artificial marble using incineration ash in accordance with an exemplary embodiment of the present invention.

Referring to FIGS. 1 and 2, at the outset, incineration fly ash of 60.0 weight percent is mixed with SiO₂ of 39.8 weight percent and additives of 0.2 weight percent for coloring, clarification, and reinforcing.

The above mixed materials are provided in a melting furnace and melted at about 1400° C. for about 1 hour. The melted materials are then discharged from the melting furnace, while being water-cooled and thereby forming granulation slag.

Next, the granulation slag is screened so as to separate fine particles according to size. Then the granulation slag is mixed with particulate and deposited in a refractory die.

The refractory die containing the slag is heat-treated in a furnace at 1000-1200° C. for about 1 hour or less and at 850-1050° C. for about 1-2 hours, thus obtaining crystallized artificial marble.

The crystallized artificial marble can manifest a variety of colors such as white green, dark green, dark blue, redish brown, navy, dimgray, olivegray, and darkkhaki, with a wide variety of patterns.

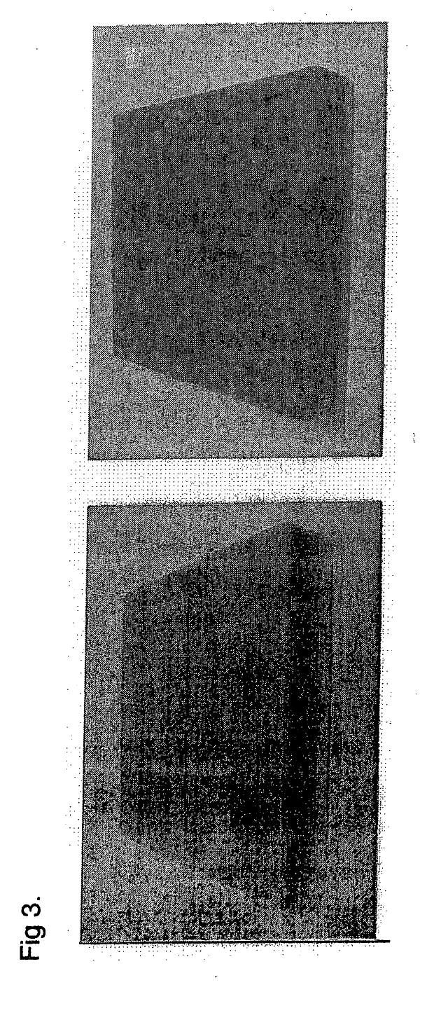

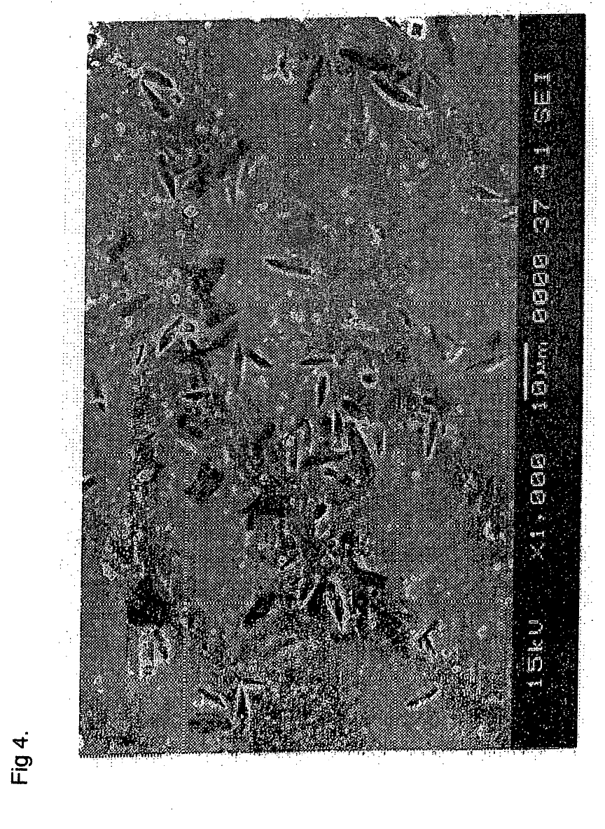

FIG. 3 is a photograph showing examples of the crystallized artificial marble. Further, FIG. 4 is a photograph showing precipitate phase produced during heat treatment in a fabrication process.

The physical properties of the crystallized artificial marble fabricated from this embodiment are shown in Table 1 in comparison with a conventional marblite, a normal marble, and fine-grained granite.

TABLE 1

| | | Conventional | Normal | Fine-grained |
|---|---|---|---|---|
| | Embodiment | Marblite | Marble | Granite |
| Specific Gravity | 2.74 | 2.7 | 2.7 | 2.6 |
| Bending Strength | 460 | 510 | 170 | 150 |
| Compressive | 3900 | 3400 | 1.6 | 1.8 |
| Strength | | | | |
| Hardness | 6.5 | 6.5 | 4 | 5.5 |
| Absorption Rate | 0.00 | 0.00 | 0.30 | 0.10 |

As shown in the above Table 1, the crystallized artificial marble of this embodiment is in no way inferior to conventional marblite, a normal marble, and fine-grained granite.

As discussed above, the crystallized artificial marble of the present invention is fabricated using incineration fly ash that contains chlorine and heavy metal in volume. Moreover, the crystallized artificial marble of the present invention is fabricated without high cost pre-treatment process such as washing and drying, while regulating basicity only with some additives and SiO₂. If the SiO₂ content is below 20 weight percent, it may be difficult to control basicity. On the other hand, if the SiO₂ content is over 50 weight percent, it may be difficult to form products. It is therefore desirable that the content of SiO₂ varies from 20 to 50 weight percent.

The fabrication method of the present invention does not require pre-treatment process such as washing and drying, so the entire fabrication process is simplified and related cost is reduced. Further, it is possible not only to manifest various elegant marble patterns by regulating particle sizes, but also to manifest various colors by adding a little oxide such as TiO₂, ZrO₂, CaF₂, ZnO, PbO, Cr₂O₃, MnO₂, Co₃O₄, NiO, CuO, SeO₂, and Cd(NO₃)₂.

Accordingly, the crystallized artificial marble of this invention has soft texture, excellent stiffness, and good weatherability. Additionally, the crystallized artificial marble of the invention can be thinned to a thickness of 10 mm or less, so it may be utilized for a wide range of residential and commercial applications.

While this invention has been particularly shown and described with reference to exemplary embodiments thereof, it will be understood by those skilled in the art that various changes in form and details may be made therein without departing from the spirit and scope of the invention as defined by the appended claims.

1. A method for fabricating a crystallized artificial marble using incineration ash, the method comprising:
mixing incineration fly ash of 50 to 80 weight percent with SiO₂ of 20 to 50 weight percent and additives of 0.1 to 3 weight percent for coloring, clarification, and reinforcing;
melting the mixed incineration fly ash at 1300 to 1500° C. for 0.5 to 1.5 hours;
water-cooling the melting incineration fly ash so as to form granulation slag;
screening the granulation slag so as to separate fine particles according to size;
depositing the granulation slag in a refractory die after mixing with particulate; and
heat-treating the granulation slag at 1000-1200° C. for about 1 hour or less and at 850-1050° C. for about 2 hours or less.

2. The method of claim 1, wherein the additives include at least one coloring additive selected among TiO₂, ZrO₂, CaF₂, ZnO, PbO, Cr₂O₃, MnO₂, Co₃O₄, NiO, CuO, SeO₂, and Cd(NO₃)₂, and at least one reinforcing additive selected among Na₂O, B₂O₃, and CaF₂.

3. A crystallized artificial marble fabricated from the method described in claim 1.

4. A crystallized artificial marble fabricated from the method described in claim 2.
